(19) United States
(12) Patent Application Publication
(10) Pub. No.: US 2022/0032543 A1
(43) Pub. Date: Feb. 3, 2022

(54) ADDITIVE MANUFACTURING MACHINE HAVING A COMPACTLY ARRANGED ACTUATOR

(71) Applicant: AddUp, Cebazat (FR)

(72) Inventors: GILLES WALRAND, CEBAZAT (FR); DAVID OLSOMMER, CLERMONT-FERRAND (FR); ALBIN EFFERNELLI, CEBAZAT (FR)

(21) Appl. No.: 17/312,612

(22) PCT Filed: Dec. 9, 2019
(86) PCT No.: PCT/FR2019/052978

§ 371 Date: Jun. 10, 2021

(30) Foreign Application Priority Data
Dec. 10, 2018 (FR) 1872567

(51) Int. Cl. B29C 64/232; B29C 64/153; B29C 64/245; B29C 64/255

(52) U.S. Cl. CPC B29C 64/232; B29C 64/153; B33Y 10/00; B29C 64/255; B29C 64/245

(57) ABSTRACT

An additive manufacturing machine comprises a work surface, a build sleeve (44), and a build platform (46) moving translationally between a raised position and a lowered position under the effect of an actuator (48), the platform being connected to the actuator by a support (50). The build sleeve (44) comprises a slot (66) allowing the support (50) to pass through the build sleeve to connect the platform to the actuator when the build platform translates from its raised position to its lowered position, a closing-off element (68) allowing a slot (66) to be closed off progressively as the platform effects its translational movement inside the sleeve from its raised position to its lowered position, a closing-off element (68) being a tape (70), and the upper end (U70) of a closing-off tape being fixed to the upper edge of the build sleeve or to the work surface.

The present invention relates to a powder bed fusion additive manufacturing machine of compact arrangement.

More specifically, the invention relates to a compact arrangement of the actuator or actuators used to move a platform on which components are manufactured using a powder bed fusion additive manufacturing method.

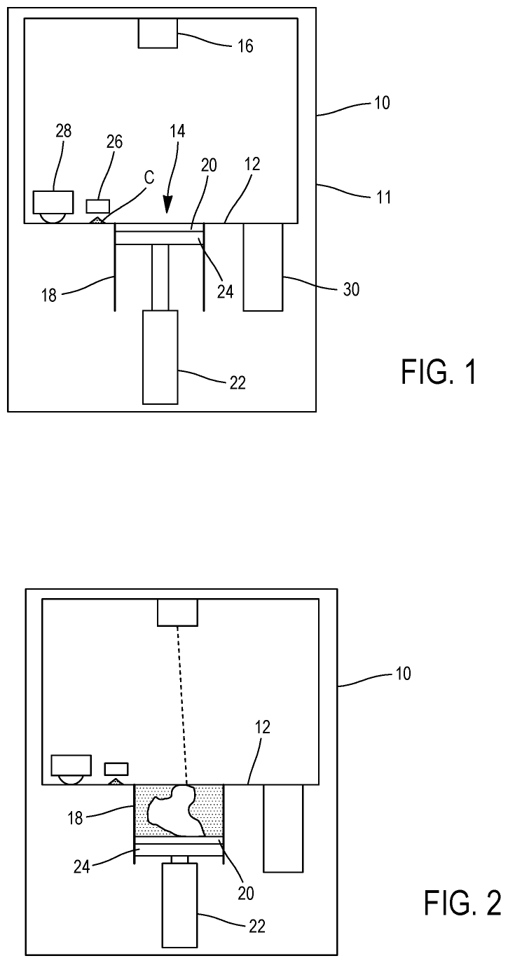

FIGS. 1 and 2 depict a known powder bed fusion additive manufacturing machine 10 of the prior art. This additive manufacturing machine 10 comprises, within a build chamber 11, a work surface 12, comprising a work zone 14 able to receive a superposition of various layers of powder, and a selective-consolidation device 16 for consolidating the layers of powder.

The work zone 14 is defined by a build sleeve 18 and a build platform 20. The build sleeve 18 extends vertically beneath the work surface 12 and opens into the work surface. The build platform 20 slides vertically inside the build sleeve 18 under the effect of a ram 22. The build platform 20 is mounted on the ram 22 via a support 24.

The additive manufacturing machine 10 comprises a powder distribution device 26 able to deposit a line C of powder on the work surface 12 and a powder-spreading device 28 able to spread the line C of powder over the work zone 14. The additive manufacturing machine 10 also comprises a reservoir 30 able to recover excess powder deposited in the creation of each layer of powder.

At the start of manufacture, and as illustrated in FIG. 1, the ram is fully extended and the build platform 20 lies in the plane of the work surface.

At the end of manufacture, and as illustrated in FIG. 2, the build platform 20 is situated at the bottom of the build sleeve 18 and the ram is fully retracted.

As FIG. 2 shows, the height of the work surface is determined by the sum of the height of the build sleeve and the height of the ram when fully retracted.

In order to allow the platform to travel the entire height of the build sleeve, the ram needs to have a stroke at least equal to the height of the build sleeve.

As a result, the heightwise bulk of the ram when fully retracted is at least equal to the height of the build sleeve, and the work surface needs to be situated at a height at least equal to twice the height of the build sleeve.

The driving of a translational movement of a build platform by a ram according to the prior art has disadvantages.

On the one hand, in order to reduce the height of the work surface and the overall bulk of the machine, it is necessary to reduce the height of the build sleeve and therefore the height of the parts manufactured, something which opposes improvements to the production capabilities of the additive manufacturing machine.

On the other hand, in order to manufacture parts of greater height, it is necessary to increase the height of the build sleeve and the stroke of the ram, and therefore to raise the work surface by the height added to the build sleeve and the stroke added to the ram, something which opposes the accessibility of the work surface and opposes the ability to reduce the overall bulk of the additive manufacturing machine.

Document WO 2018/007941 proposes an arrangement that allows very tall parts to be manufactured without raising the work surface of the machine excessively. In that arrangement, actuators situated outside the build sleeve are connected to the build platform by supports passing through the walls of the sleeve via slots provided for that purpose in the height of the build sleeve. As the platform progressively descends, metal strips fixed to the build platform begin to close off the slots in the build sleeve.

As a result, with the arrangement proposed in document WO 2018/007941, the closing-off strips at the start of manufacture protrude by their entire length above the work surface and continue to protrude above the work surface until such point as the platform reaches its lowest position in the sleeve.

By protruding above the work surface in this way, the closing-off strips provided in document WO 2018/007941 disturb the flow of the air streams used to remove the fumes resulting from the selective consolidation of the powder by melting, and these strips complicate the spreading of the layers of powder on top of the build platform.

It is an objective of the present invention to provide a powder bed fusion additive manufacturing machine the arrangement of which allows the height of the build sleeve, and therefore of the parts manufactured, to be increased without raising the work surface and without increasing the overall bulk of the machine.

Alternatively, the invention proposes a powder bed fusion additive manufacturing machine arrangement that allows the height of the work surface, and therefore the overall bulk of the machine, to be reduced while at the same time maintaining a build sleeve of the same height, and therefore the same part production capabilities, as a machine of the prior art in which the build platform is driven in a translational movement by a ram.

Advantageously, the invention is able to achieve the above-mentioned objectives while at the same time avoiding disturbing the flow of the air streams used to remove the fumes resulting from the selective consolidation of the powder by melting, and avoiding complicating the spreading of the layers of powder on top of the build platform.

To this end, the subject of the invention is a powder bed fusion additive manufacturing machine, this additive manufacturing machine comprising a work surface, a build sleeve extending from the work surface and below the work surface, and a build platform moving translationally between a raised position and a lowered position inside the build sleeve under the effect of an actuator, the platform being connected to the actuator by a support, the build sleeve comprising a slot in its height allowing the support to pass through the build sleeve to connect the platform to the actuator when the build platform translates from its raised position to its lowered position in the build sleeve, a closing-off element allowing a slot in the sleeve to be closed off progressively as the platform effects its translational movement inside the sleeve from its raised position to its lowered position, a closing-off element being a tape.

According to the invention, the upper end of a closing-off tape is fixed to the upper edge of the build sleeve or to the work surface.

Thanks to the slot in the build sleeve, the actuator can be positioned next to the build sleeve and free up the space beneath the build sleeve. The space thus freed up can be used to reduce the height of the work surface, and therefore the overall bulk of the machine, or to increase the height of the build sleeve, and therefore the height of the parts manufactured.

Fixing the upper end of a closing-of tape to the upper edge of the build sleeve or to the work surface ensures that this closing-off element will not disturb either the flow of the air streams above the work surface of the machine, or the spreading of the layers of powder on top of the build platform.

The invention also makes the following provisions:
the bottom end of a closing-off tape is connected to a tape tensioning device,
a tape tensioning device is positioned inside the build sleeve and beneath the build platform,
a tape tensioning device comprises at least a spring connecting the bottom end of the tape to a fixed part of the machine, and a leaf spring pressing against the tape,
a support connecting the platform to an actuator comprises an end-stop countering the force on the tape, the counteracting force exerted by the end-stop of a support on a tape opposing the pressing force exerted by the leaf spring of the tensioning device pressing against this tape,
a functional clearance is provided between the build sleeve and platform so that a tape can pass between the build sleeve and platform,
a tape adopts the form of a length of metal strip,
a closing-off element also comprises a covering wall manufactured as the platform progressively effects its translational movement in the build sleeve,
an actuator driving the platform in translational movement inside the build sleeve is positioned outside the build sleeve,
with an actuator driving the platform in translational movement inside the build sleeve via a support, this actuator extends above this support when the platform is in its lowered position inside the build sleeve,
an actuator driving the platform in translational movement inside the build sleeve extends below the work surface,
with an actuator driving the platform in translational movement inside the build sleeve via a support, this actuator extends below this support when the platform is in its raised position inside the build sleeve,
an actuator adopts the form of a threaded spindle driven in rotation by a motor, a support comprising a nut screwed onto the threaded spindle,
the build platform moves translationally between its raised position and its lowered position inside the build sleeve under the effect of several actuators, the platform being connected to each actuator by a support, and the build sleeve comprises several slots in its height, allowing a support to pass through the build sleeve to connect the build platform to each actuator as the build platform effects its translational movement from its raised position to its lowered position in the build sleeve,
the build platform effects a translational movement between its raised position and its lowered position inside the build sleeve under the effect of three actuators uniformly distributed around the build sleeve.

Further features and advantages of the invention will become apparent from the following description. This description, given by way of non-limiting example, refers to the appended drawings, in which:

FIG. 1 is a schematic face-on and sectioned view of a powder bed fusion additive manufacturing machine of the prior art, with its build platform in the raised position,

FIG. 2 is a schematic face-on and sectioned view of a powder bed fusion additive manufacturing machine of the prior art, with its build platform in the lowered position,

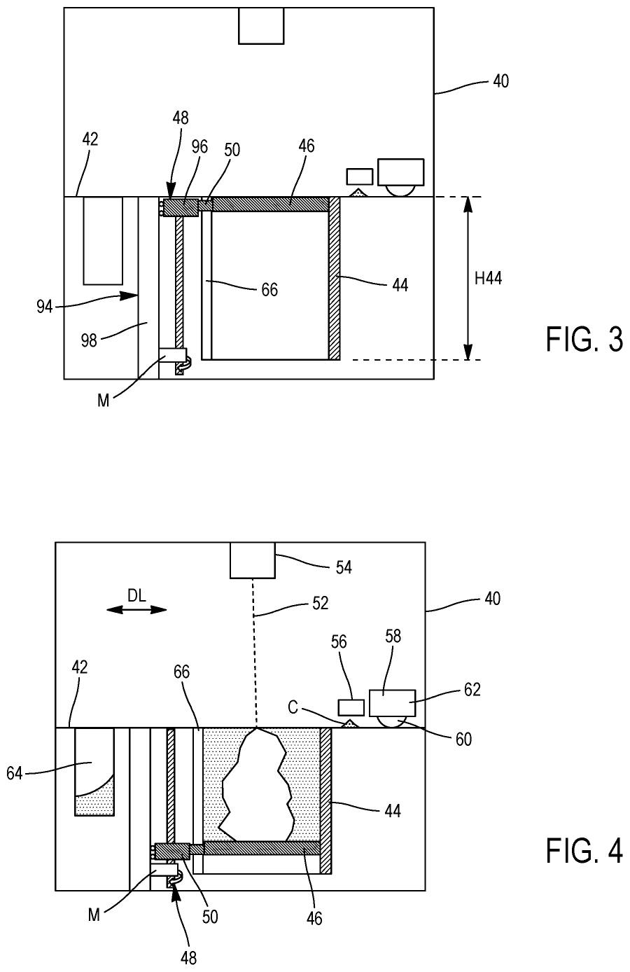

FIG. 3 is a schematic face-on and sectioned view of a powder bed fusion additive manufacturing machine according to the invention, with its build platform in the raised position,

FIG. 4 is a schematic face-on and sectioned view of a powder bed fusion additive manufacturing machine according to the invention, with its build platform in the lowered position,

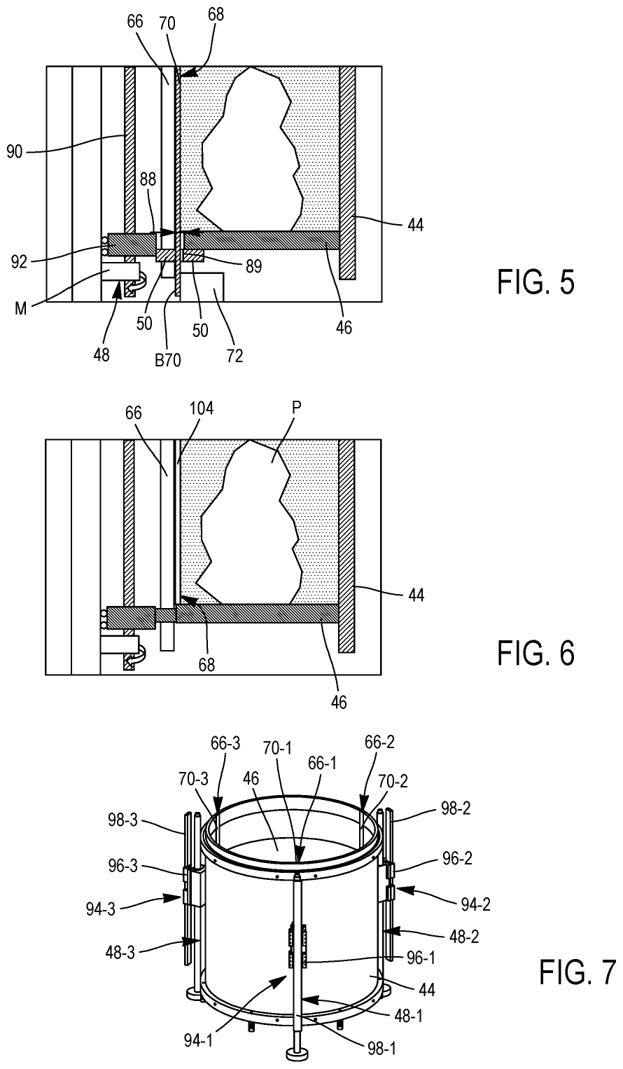

FIG. 5 is a schematic face-on and sectioned view of a powder bed fusion additive manufacturing machine according to the invention, with a closing-off element in the form of a tape able to close off a slot in a build sleeve,

FIG. 6 is a perspective and sectioned view of a powder bed fusion additive manufacturing machine according to the invention, with a closing-off element in the form of a tape able to close off a slot in a build sleeve,

FIG. 7 is a schematic face-on and sectioned view of a powder bed fusion additive manufacturing machine according to the invention, with a closing-off element in the form of a covering wall able to close off a slot in a build sleeve,

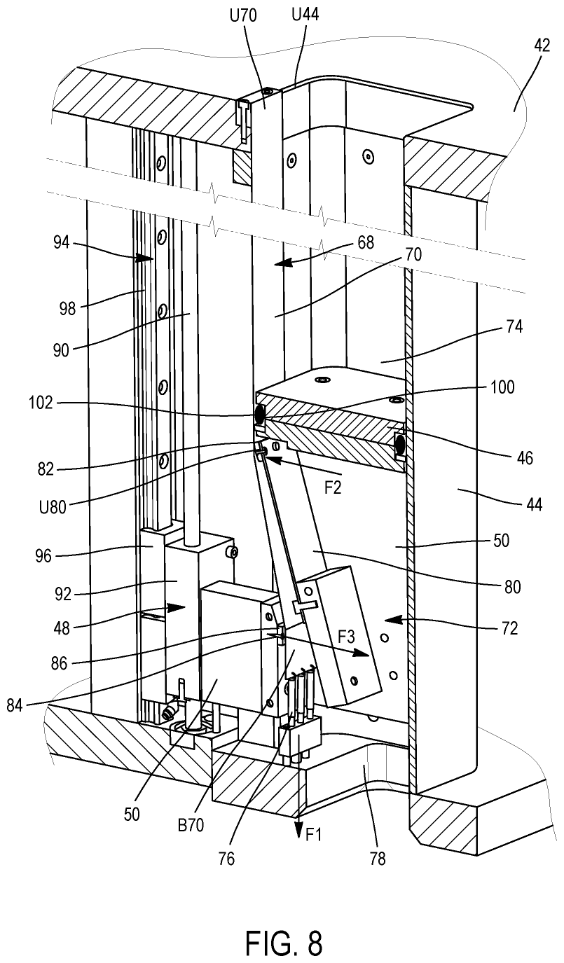

FIG. 8 is a perspective view of a build sleeve of a powder bed fusion additive manufacturing machine according to the invention with several slots and several actuators.

The invention relates to a powder bed fusion additive manufacturing machine. Powder bed fusion additive manufacturing is an additive manufacturing method in which one or more parts are manufactured by the selective consolidation of various mutually superposed layers of additive manufacturing powder. The consolidation is said to be selective because only zones of the powder layers that correspond to sections of the parts that are to be manufactured are consolidated.

For example, the part or parts are manufactured by the selective melting of various mutually superposed layers of additive manufacturing powder. The melting may be full or partial (sintering). The selective melting can be obtained using a laser beam (Selective Laser Melting) and/or using an electron beam (Electron Beam Melting).

In order to implement powder bed fusion additive manufacturing, the additive manufacturing machine 40 according to the invention comprises a work surface 42, a build sleeve 44 extending from the work surface and below the work surface, and a build platform 46 moving translationally between a raised position, illustrated in FIG. 3, and a lowered position, illustrated in FIG. 4, inside the build sleeve under the effect of an actuator 48. The platform 46 is connected to the actuator 48 by a support 50.

The platform 46 is able to receive a superposition of various layers of powder as it progressively descends down inside the build sleeve under the effect of the actuator 48.

For the selective consolidation of the layers of powder, the machine 40 comprises at least one beam 52 emitted by at least one source 54. A beam 52 is, for example, a laser beam emitted by a laser source. In a variant, several beams 52 may be emitted by several laser sources, such as laser diodes for example. Still in a variant, a beam 52 may be an electron beam emitted by an electron gun. One or more laser beam(s) may also be combined with one or more electron beam(s). In order to allow selective consolidation of a layer of powder, which is to say consolidation according to predetermined patterns and paths corresponding to sections of the parts that are to be manufactured, a source 54 is associated with means for moving and controlling the beam or beams 52. For example, mirrors, optical lenses and/or mechanical actuators can be used to move and modify one or more laser beams, while electromagnetic coils can be used to move and control an electron beam.

The work surface 42 is horizontal. The sleeve 44 extends vertically beneath the work surface 42, namely about a vertical axis. The sleeve 44 opens for example onto the work surface 42 via an opening made in the work surface.

In the example illustrated in FIGS. 3 and 4, the work surface 42 and the sleeve 44 are mounted fixed, and the build platform 46 moves in vertical translation in the sleeve 44 under the effect of the actuator 48.

In order to create the various layers of powder used in the additive manufacture of the part or parts that are to be manufactured, the additive manufacturing machine 40 comprises a powder distribution device 56 able to deposit at least one line C of powder on the work surface 42 and a powder-spreading device 58 able to spread the line of powder deposited by the distribution device over the platform 46.

The powder distribution device 56 may take the form of an injector able to move over the work surface 42 or of a drawer associated with a powder metering device and sliding in a groove made in the work surface.

The spreading device 58 adopts the form of a scraper or of a roller 60 mounted on a carriage 62. This carriage 62 is mounted with the ability to move in translation in a longitudinal horizontal direction DL above the work surface 42.

The additive manufacturing machine 40 also comprises a reservoir 64 able to recover excess powder deposited in the creation of each layer of powder.

In order to manufacture parts exhibiting symmetry of revolution or to improve the mechanical ability of the build sleeve 44 to withstand a vacuum with a view to electron beam melting additive manufacture, the build sleeve 44 may adopt the form of a right circular cylinder. The build sleeve 44 may also adopt the form of other right cylinders, on a polygonal, rectangular, square, elliptical, etc. base.

In parallel with an actuator 48, the machine comprises a guide device 94 guiding translational movement of the platform in the sleeve, the platform being connected to a guide device 94 by a support 50. A guide device 94 comprises a runner 96 fixed to the support 50 and mounted on a vertical guide rail 98.

According to the invention, the build sleeve 44 comprises a slot 66 in its height H44 allowing the support 50 to pass through the build sleeve to connect the platform 46 to the actuator 48 when the build platform translates from its raised position to its lowered position in the build sleeve. A slot 66 also allows the support 50 to pass through the build sleeve to connect the platform 46 to the actuator 48 when the build platform translates from its lowered position to its raised position in the build sleeve.

Since the build sleeve 44 extends vertically beneath the work surface 42, a slot 66 likewise extends vertically. For example, a slot 66 extends over the entire height H44 of the build sleeve 44. For example, a slot 66 extends in a rectilinear fashion over the entire height H44 of the build sleeve 44.

To give an idea of scale, the width of a slot 66 is a few millimetres, while the height H44 of a sleeve measures several tens of centimetres.

Advantageously, and as shown by FIGS. 3 and 4, the slot 66 allows an actuator 48 to be positioned next to the build sleeve 44 rather than beneath same.

In order to keep the non-consolidated powder inside the sleeve during the course of manufacture, a closing-off element 68 allows a slot 66 in the sleeve to be closed off progressively as the platform effects its translational movement inside the sleeve from its raised position to its lowered position.

The closing-off element 68 also allows a slot 66 in the sleeve to be closed off progressively as the platform effects its translational movement inside the sleeve from its lowered position to its raised position.

As illustrated by FIGS. 5 and 6, a closing-off element 68 is, for example, a tape 70. For example, this tape 70 takes the form of a length of metal strip. Alternatively, this tape 70 is made of Kevlar. A tape has, for example, a thickness of 0.5 millimetres and a width of 50 millimetres.

For optimal closing-off of a slot 66, the width of the tape 70 is greater than the width of the slot. For example, the width of the tape 70 is 40% greater than the width of the slot that it covers. For example, for a slot with a width of 35 millimetres, the tape has a width of 50 millimetres.

The upper end U70 of a closing-off tape is fixed, for example using screws, to the upper edge U44 of the build sleeve or to the work surface 42.

At the same time, the tape 70 is also pressed closely against the interior wall 74 of the build sleeve 44 by the build platform 46.

Still with a view to optimal closing-off of a slot 66 and to avoiding leaks of powder through a slot 66 as the platform progressively descends down inside the sleeve, the bottom end B70 of a closing-off tape is connected to a tape tensioning device 72.

A tape 70 lies between the build sleeve 44 and the build platform 46, namely inside the sleeve 44. Also, a tape tensioning device 72 is positioned inside the build sleeve 44 and beneath the build platform 46.

In order to keep a tape 70 pressed against the interior wall 74 of the build sleeve 44, a tape tensioning device 72 comprises at least a spring 76 connecting the bottom end B70 of the tape to a fixed part 78 of the machine, and a leaf spring 80 pressing against the tape. A spring 76 is a component which exerts a force as a result of its elastic properties. A spring 76 may be a helical spring, a spring leaf, a ram. A spring 76 applies a substantially vertical and downwards tensioning force F1 on a tape 70 so as to tension the tape along its length. The leaf spring 80 applies a substantially horizontal pressing force F2 directed towards the interior wall 74 of the build sleeve 44 so as to press the tape 70 closely against the interior wall 74 of the build sleeve 44.

In order to distribute the tensioning force over the tape, a tape tensioning device 72 comprises several springs 76 connecting the bottom end B70 of the tape to a fixed part 78 of the machine, as illustrated in FIG. 6.

In order to accompany the translational movements of the platform 46 and apply its force to the tape as close as possible to the platform 46 whatever the position of the platform inside the sleeve 44, the leaf spring 80 is mounted on the support 50. For example, the upper end U80 of the leaf spring 80 presses against the tape 70 immediately beneath the platform 46. The upper end U80 of the leaf spring 80 may be fitted with a shoe 82 aimed at limiting the friction of the leaf spring against the tape.

In order to keep the bottom end B70 and the spring or springs 76 in the one same vertical plane whatever the position of the platform and of the support in the sleeve 44, a support 50 connecting the platform 46 to an actuator 48 comprises an end-stop 84 countering the force on the tape 70. The counteracting force F3 exerted by the end-stop 84 of a support on a tape opposes the pressing force F2 exerted by the leaf spring 80 of the tensioning device pressing against this tape. The counteracting force F3 is substantially horizontal and directed towards the inside of the build sleeve 44 so as to push the tape 70 away from the interior wall 74 of the build sleeve 44. The end-stop 84 may be fitted with a shoe 86 aimed at limiting the friction of the end-stop 84 against the tape.

Because the upper end U70 of a closing-off tape is fixed to the upper edge U44 of the build sleeve and/or to the work surface 42, and because the bottom end B70 of a tape is fixed to a fixed part 78 of the machine below the platform 46, the tape 70 has to pass between the platform 46 and the build sleeve 44. A functional clearance 88 between the build sleeve 44 and platform allows the platform to effect the translational movement in the sleeve without jamming. More specifically, this functional clearance 88 is provided between the periphery of the platform and the interior wall of the sleeve. This functional clearance 88 may be sufficient to allow one or more tape(s) 70 to pass between the build sleeve 44 and platform 46. If not, the magnitude of the functional clearance 88 may be increased in order to allow one or more tape(s) 70 to pass between the build sleeve 44 and platform 46. The magnitude of a functional clearance 88 that allows one or more tape(s) 70 to pass is, for example, 2 to 5 millimetres.

As an alternative to the functional clearance 88, a vertical groove may be provided at the periphery of the platform or a vertical groove may be provided in the interior wall of the sleeve so that a tape can pass between the sleeve and the platform.

FIG. 6 illustrates how the support 50 is able to support the build platform 46 while at the same time allowing the tape 70 to pass between the sleeve 44 and the platform. To do this, the bottom end B70 of the tape 70 is offset towards the centre of the sleeve 44. Thanks to this offsetting of the bottom end B70 of the tape 70 towards the centre of the sleeve 44, the support is able to enter the sleeve 44 and pass between the interior wall 74 of the sleeve and the tape 70 in order to support the platform 46.

As shown in FIG. 7, a closing-off element 68 may also take the form of a covering wall 104 manufactured as the platform progressively effects its translational movement in the build sleeve. More specifically, the covering wall 104 is made up of a certain quantity of powder consolidated, that is to say by sintering or by fusion, facing a slot 66. The covering wall 104 is additively manufactured at the same time as a part P is manufactured on the platform 46. The covering wall 104 has, for example, a thickness of a few millimetres and a width of 50 millimetres. For optimal closing-off of a slot 66, the width of the covering wall 104 is greater than the width of the slot. For example, the width of the covering wall 104 is 40% greater than the width of the slot that it covers. For example, for a slot with a width of 35 millimetres, the covering wall 104 has a width of 50 millimetres.

A closing-off element 68 may also comprise both a tape 70 and a covering wall 104. In that case, the tape 70 is in contact with the interior wall of the sleeve, and the wall 104 covers the tape 70.

As shown in the various figures, and because a slot 66 allows a support 50 to pass through the sleeve 46 over the entire height thereof, an actuator 48 driving the translational movement of the platform 46 inside the build sleeve 44 is positioned outside the build sleeve. For example, an actuator 48 is positioned parallel to the build sleeve and on the outside thereof.

In order to limit the height of the work surface 42 and the overall bulk of the machine, with an actuator 48 driving the platform in translational movement inside the build sleeve via a support 50, this actuator extends above this support 50 when the platform 46 is in its lowered position inside the build sleeve.

Again in order to limit the height of the work surface 42 and the overall bulk of the machine, an actuator 48 driving the platform in translational movement inside the build sleeve extends below the work surface 42.

More specifically, with an actuator 48 driving the platform in translational movement inside the build sleeve via a support 50, this actuator 48 extends below this support 50 when the platform is in its raised position inside the build sleeve.

In order to conform to the aforementioned constraints on bulk, an actuator adopts, for example, the form of a threaded spindle 90 driven in rotation by a motor M, the support 50 comprising a nut 92 screwed onto the threaded spindle. An actuator 48 may also adopt the form of a ball screw turned by a motor M or of a rack-and-pinion assembly with a pinion turned by a motor.

In order to avoid a setup with unsupported overhang having just one support and one actuator, particularly in the case of a sleeve and platform of large dimensions, the build platform 46 effects its translational movement between its raised position and its lowered position inside the build sleeve 44 under the effect of several actuators 48-1,48-2,48-3, the build platform 46 being connected to each actuator by a support 50. As shown in FIG. 8, the build sleeve 44 comprises several slots 66-1, 66-2,66-3 in its height H44 allowing a support 50 to pass through the build sleeve to connect the build platform to each actuator 48-1,48-2,48-3 when the build platform translates from its raised position to its lowered position in the build sleeve, and when the build platform translates from its lowered position to its raised position in the build sleeve.

In instances in which the build sleeve 44 comprises several slots 66-1,66-2,66-3, the machine comprises several closing-off tapes 70-1,70-2,70-3 able to close off each slot 66-1,66-2,66-3 of the sleeve when the platform progressively translates from its raised position to its lowered position in the sleeve, and when the platform progressively translates from its lowered position to its raised position in the sleeve.

As in the example illustrated in FIG. 8, the platform 46 effects its translational movement between its raised position and its lowered position inside the build sleeve 44 under the effect of three actuators 48-1,48-2,48-3 distributed uniformly, each at 120 degrees from the other two, around the build sleeve.

In parallel with the three actuators 48-1,48-2,48-3, the machine comprises three guide devices 94-1, 94-2,94-3 providing translational guidance to the support and therefore to the platform. Each guide device 94-1,94-2,94-3 comprises a runner 96-1,96-2,96-3 fixed to the support 50 and mounted on a vertical guide rail 98-1,98-2,98-3.

As shown in FIG. 6, a platform 46 comprises a peripheral housing 100 for at least one seal 102 sealing against the powder. A seal 102 takes, for example, the form of a metal or ceramic braid. This seal 102 compensates for the overthickness generated by one or more tape(s) 70 between the platform and the sleeve and prevents powder from flowing between the platform and the sleeve as a result of the functional clearance 88.

In the present invention, the actuator or actuators are separate from the guide device or devices because the actuators need to withstand very high loads at the end of manufacture, particularly in the case of the additive manufacture of parts of great height, and very precise guidance, to within the order of a few micrometres, of the platform is needed in order to achieve powder layers a few tens of micrometres thick and the thickness of which is constant.

1.-15. (canceled)

16. A powder bed fusion additive manufacturing machine comprising:
a work surface;
a build sleeve extending from the work surface and below the work surface; and
a build platform moving translationally between a raised position and a lowered position inside the build sleeve under the effect of an actuator,
the build platform being connected to the actuator by a support,
the build sleeve comprising a slot in its height allowing the support to pass through the build sleeve to connect the build platform to the actuator when the build platform translates from the raised position to the lowered position in the build sleeve,
a closing-off element allowing a slot in the build sleeve to be closed off progressively as the build platform effects translational movement inside the build sleeve from the raised position to the lowered position,
a closing-off element being a tape,
wherein an upper end of the tape is fixed to an upper edge of the build sleeve or to the work surface.

17. The powder bed fusion additive manufacturing machine according to claim 16, wherein a bottom end of the tape is connected to a tape tensioning device.

18. The powder bed fusion additive manufacturing machine according to claim 17, wherein the tape tensioning device is positioned inside the build sleeve and beneath the build platform.

19. The powder bed fusion additive manufacturing machine according to claim 17, wherein the tape tensioning device comprises at least a spring connecting the bottom end of the tape to a fixed part of the powder bed fusion additive manufacturing machine, and a leaf spring pressing against the tape.

20. The powder bed fusion additive manufacturing machine according to claim 19, wherein a support connecting the build platform to the actuator comprises an end-stop counteracting the force on the tape, a counteracting force exerted by the end-stop opposing a pressing force exerted by the leaf spring of the tensioning device pressing against the tape.

21. The powder bed fusion additive manufacturing machine according to claim 16, wherein a functional clearance is provided between the build sleeve and build platform so that a tape can pass between the build sleeve and build platform.

22. The powder bed fusion additive manufacturing machine according to claim 16, wherein a tape adopts a form of a length of a metal strip.

23. The powder bed fusion additive manufacturing machine according to claim 16, wherein a closing-off element further comprises a covering wall manufactured as the build platform progressively effects translational movement in the build sleeve.

24. The powder bed fusion additive manufacturing machine according to claim 16, wherein the actuator driving the build platform in translational movement inside the build sleeve is positioned outside the build sleeve.

25. The powder bed fusion additive manufacturing machine according to claim 16, wherein, with the actuator driving the build platform in translational movement inside the build sleeve via the support, the actuator extends above the support when the build platform is in the lowered position inside the build sleeve.

26. The powder bed fusion additive manufacturing machine according to claim 25, wherein the actuator driving the build platform in translational movement inside the build sleeve extends below the work surface.

27. The powder bed fusion additive manufacturing machine according to claim 26, wherein, with the actuator driving the build platform in translational movement inside the build sleeve via the support, the actuator extends below the support when the build platform is in the raised position inside the build sleeve.

28. The powder bed fusion additive manufacturing machine according to claim 16, wherein the actuator adopts a form of a threaded spindle driven in rotation by a motor, the support comprising a nut screwed onto the threaded spindle.

29. The powder bed fusion additive manufacturing machine according to claim 16, wherein the build platform moves translationally between the raised position and the lowered position inside the build sleeve under the effect of several actuators, the build platform being connected to each actuator by a support, and wherein the build sleeve comprises several slots in its height, allowing a support to pass through the build sleeve to connect the build platform to each actuator as the build platform effects translational movement from the raised position to the lowered position in the build sleeve.

30. The powder bed fusion additive manufacturing machine according to claim 29, wherein the build platform effects translational movement between the raised position and the lowered position inside the build sleeve under the effect of three actuators uniformly distributed around the build sleeve.
